(19) United States
(12) Patent Application Publication
(10) Pub. No.: US 2024/0351500 A1
(43) Pub. Date: Oct. 24, 2024

(54) PORTABLE LOAD ASSISTANT

(71) Applicant: Mortuary Lift Company, Inc., Cedar Rapids, IA (US)

(72) Inventors: Katie Hill, Cedar Rapids, IA (US); Matthew Lensch, Cedar Rapids, IA (US)

(21) Appl. No.: 18/640,257

(22) Filed: Apr. 19, 2024

Related U.S. Application Data
(60) Provisional application No. 63/460,735, filed on Apr. 20, 2023.
(60) Provisional application No. 63/528,741, filed on Jul. 25, 2023.

(51) Int. Cl. B60P 1/00; B66D 1/28

(52) U.S. Cl. CPC B60P 1/00; B66D 1/28

(57) ABSTRACT

The present invention comprises a system for winching cargo into a vehicle and includes a winch, at least one load attachment device, and at least one seat belt attachment device. The seat belt attachment device anchors the remaining components (preferably the winch) to seat belt buckles already within the vehicle. The load attachment device connects to the cargo to be loaded on one end and the winch on the other end, via a tether. The winch is then operated to draw in the tether, which in turn draws the cargo toward the winch and into the vehicle. Because the seat belt attachment device provides a strong but reversible attachment to the vehicle, the present invention is easy to temporarily install on a vehicle, move between vehicles, and easy to use on stock vehicles without requiring customization of the vehicle.

### CLAIM OF PRIORITY

The present application claims the benefit of U.S. Patent Application 63/460,735, filed on Apr. 20, 2023, and U.S. Patent Application 63/528,741, filed on Jul. 25, 2023, both of which are incorporated by reference.

### FIELD OF THE INVENTION

The invention relates to a device for assisting the loading/heaving of items into a vehicle, and more generally, a portable device for transferring loads.

### BACKGROUND OF THE INVENTION

Vehicles are used to transport all manner of heavy cargo. However, loading cargo into a vehicle can be cumbersome, especially for a single vehicle operator. Besides the bulk size of the cargo, the operator has to contend with the weight of cargo. Combined together, the bulk and weight of the cargo can make it improbable or impossible for a single person to safely load the cargo into the vehicle. A variety of winch systems have been used. However, known solutions require a purpose-built attachment point within the vehicle, thus limiting known winch systems to custom or modified vehicles. The present invention overcomes the limitations of known systems.

### SUMMARY OF THE INVENTION

The present invention comprises a system for winching cargo into a vehicle and includes a winch, at least one load attachment device, and at least one seat belt attachment device. The seat belt attachment device anchors the remaining components (preferably the winch) to seat belt buckles already within the vehicle. The load attachment device connects to the cargo to be loaded on one end and the winch on the other end, via a tether. The winch is then operated to draw in the tether, which in turn draws the cargo toward the winch and into the vehicle. Because the seat belt attachment device provides a strong but reversible attachment to the vehicle, the present invention is easy to temporarily install on a vehicle, move between vehicles, and easy to use on stock vehicles without requiring customization of the vehicle.

### BRIEF DESCRIPTION OF THE DRAWINGS

FIG. 1 shows an oblique view of the portable load assistant.

FIG. 2 shows a partial, oblique view of the portable load assistant.

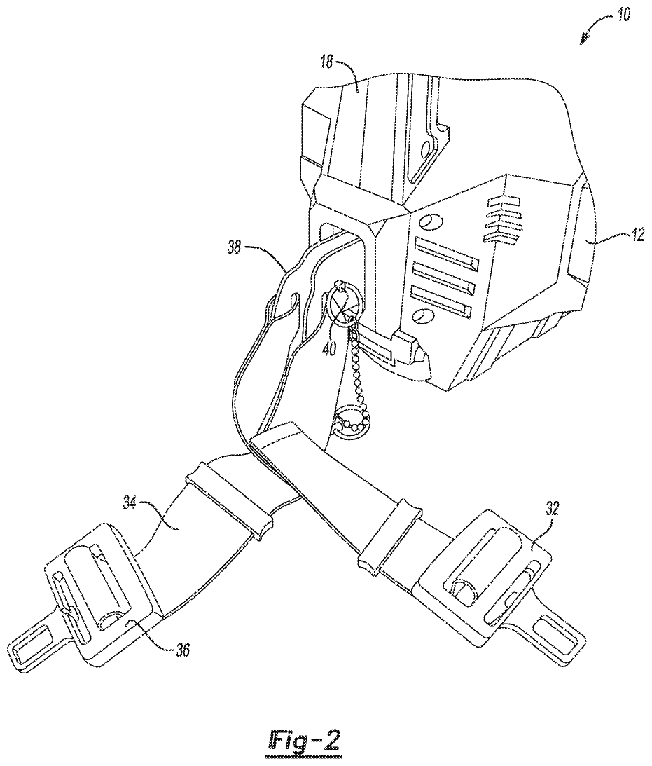

### DETAILED DESCRIPTION

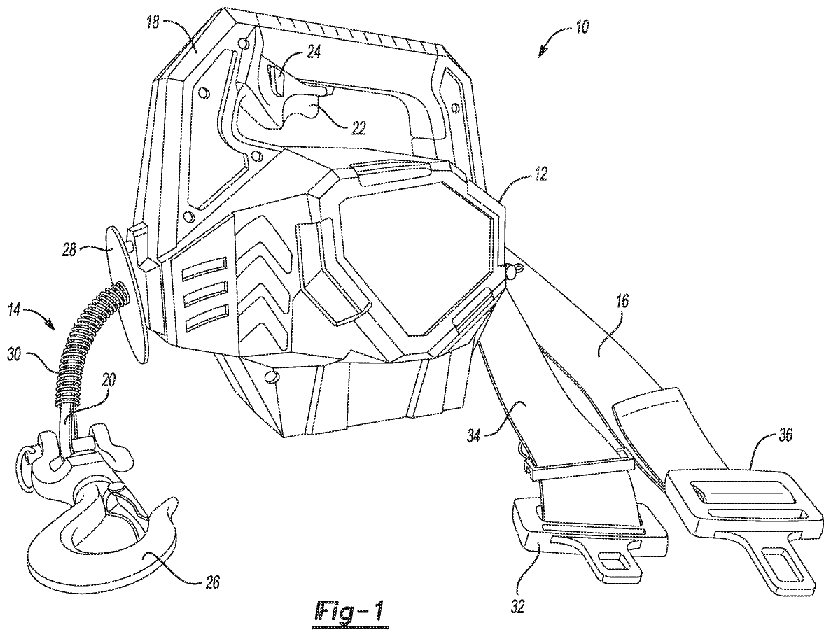

The portable load assistant 10 of the present invention comprises a winch 12, at least one load attachment device 14 and at least one seat belt attachment device 16, as seen in FIG. 1. The winch is generally located between the at least one load attachment device and the at least one seat belt attachment device so as to form a line when the portable load assistant is installed or operated. The components of the winch may be contained within a protective housing 18. The winch is any device used for hoisting or hauling, typically having a drum around which is wound a tether 20 of the load attachment device. While a hand crank winch is contemplated, a motorized winch is preferred so that the system can be operated by a single person with minimal manual effort. A more preferred motorized winch is one that has a self-contained power source, such as a battery contained within the housing. Such a winch would not require an external power source and thus improves the portability of the system. In another embodiment, the motorized winch includes a power port (e.g. in the housing), which can be connected to an external power source. For example, the power port can be connected to an inverter, which in turn is connected to vehicle power supply (e.g. a car battery). Or the power port can be connected to a battery/power source separate from the winch and the vehicle. The power port can also be used to recharge the internal battery/power supply within the winch. All of these embodiments still facilitate the portability of the system between vehicles.

In addition, the winch is preferably as light as possible, yet has sufficient winding power to hoist the desired load. Winches that weigh less than 20 pounds, less than 15 pounds, less than 10 pounds, and less than 5 pounds are most preferred. The winding power of the winch is typically proportional to the size of the motor, and so that larger winches (in physical size) typically will be able to hoist heavier loads. The winding power of the winch is selected such that it is comfortably above the weight of the load; for example, sufficient to move a load of at least 1000 lbs., a load of at least 2000 lbs., or a load of at least 3000 lbs.

Operational controls for the winch may include forward, reverse, neutral, park, etc. to wind up, or wind out the tether, freewheel the winch to allow the tether to be manually unwound, or lock the winch to hold the tether in a specific position. The operational controls may be local to the winch, either on the housing (e.g. button 22 with toggle switch 24) or via a wireline connection to the winch. The operational controls may also be remote from the winch so that the winch may be remotely controlled through an IR, RF, Bluetooth, or similar purpose built remote (e.g. a fob). The winch may also be remotely controlled through an app on a mobile device.

The winch may include one or more safety features such an auto-stop function that prevents the winch from over winding the tether or from burning-out the winch motor (because the load is too heavy).

The winch may include an additional attachment point to secure the winch to the vehicle, in addition to the seat belt attachment device discussed below. This would allow a separate attachment between the winch/housing and the vehicle to be used in vehicles that have separate (e.g. dedicated) attachment points on the vehicle, or to utilize a separate attachment as a backup to the seat belt attachment device discussed below.

The at least one load attachment device is any device that that is temporarily connectable to a load, and includes a tether that is wound around the drum in the winch. The at least one load attachment device preferably includes one or more hooks, loops, or clips, with reinforced loops of metal being preferred as are carabiners or hooks with spring closers 26, while the tether may be rope, chain, cable, or flat strapping of natural or synthetic fibers or metal. The tether may be combined with the hook, loop, or clip to increase the strength of the load attachment device. The load attachment device may include a stop 28 to prevent the winch from over winding the tether. Further, the load attachment device may include a tether protector 30 to decrease wear on the tether. The tether material is selected for a combination of strength and its ability to stay untangled.

The at least one seat belt attachment device is designed as one half of a standard seat belt buckle system for restraining passengers in vehicles and includes a connector 32 and a length of tether 34. The connector provides standardized and secure attachment point in all vehicles that carry passengers (and thus use seat belts). Preferably, the connector of the seat belt attachment includes the male buckle portion of the seat belt system (as seen in FIG. 1), so as to be buckled into the female buckle portion of a seat belt anchor point. More preferably, the seat belt attachment device includes at least two male buckle portions (each connected to its own tether) so that each attaches to a separate female portion anchored to the vehicle. The tether is preferably made of standard seat belt material, but maybe any suitable tether material discussed above.

The seat belt attachment device may also include a retractor device which stores a length of the tether, preferably seat belt material. In another embodiment, a retractor is not utilized; but rather the tether is threaded through a slip grasp device 36 that allows the tether to be held tightly, even under tension. The tether length may be set to a specific length with a stop or other mechanism (e.g. the slip grasp device). Or the length of the tether may be set by having the retractor device to remove slack from the tether. This facilitates easy connection of the seat belt attachment device to the vehicle and allows the winch to be separated from the seat belt anchor point(s) on the vehicle.

The seat belt attachment device is also attached to the winch, preferably at a joint 38 that allows one or more degrees of freedom of movement. One such possible joint incorporates a cotter pin 40 to secure the seat belt attachment device (at the end opposite the connector) to an anchor point on the winch/housing. Any suitable device may be used to attach the seat belt attachment device to the winch, with a manual device being preferred. While a permanent attachment to the winch is contemplated, a reversible connection is preferred, so that seat attachment devices can be easily removed or replaced. While the winch may include multiple joints or attachment points for the seat belt attachment device, a common location for attachment of all of the seat belt attachment devices is preferred.

Moreover, because they are standardized, the addition of anchor points for seat belt attachment devices can be made to locations in a vehicle not usually used for passengers. For example, the cargo space of cargo van or panel truck can be outfitted with the female portion of a seat belt buckle to facilitate the use of the seat belt attachment devices and thus the present invention. Thus, vehicles can be inexpensively customized to take advantage of the present invention.

The present invention can be utilized on any load that is hoist-able, drag-able, or slidable into a vehicle or onto any platform. The attachment device may be directly attachable to the load such as a coffin or attachable to a carrying device such a wheeled device carrying a coffin. Other preferred carrying devices include stretchers, with or without integrated wheels.

The present invention can be utilized on any vehicle that has seat belts and has the ability to hold or tow cargo. In one particular use case, a wagon or van is used to transport human remains, either to or from a mortuary. For example, a coffin is loaded into a hearse. Or a body on a stretcher is loaded into a coroner's vehicle. The vehicle may include components to facilitate the sliding or moving of the load into or within the vehicle such as rollers or wheels on the bed of the vehicle. The inventive device with two seat belt attachments is well suited for these situations because these vehicles typically have bucket front seats, each with a seat belt anchor located near the center line of the vehicle. The device can further be utilized in any container, whether wheeled or not, and whether or not the container has its own motor/drive train, provided that the container has (or is modified to have) seat belt attachment points to which the seat belt attachment device(s) can connect. For example, the portable load assistant could be used to load a shipping container. In another embodiment, the container or pallet is in a particular location when a load is transferred to it by the portable load assistant, such that the seat belt attachment points are separate from the container or pallet. In another embodiment, the load is a vehicle being transferred or transported.

In operation, the device is placed in the vehicle and the seat belt attachment device(s) are anchored to the vehicle, with the tether for the seat belt attachment device(s) optionally played-out. The tether for the load is unwound or played-out to a length that can be attached to the load. Once attached, the winch is operated to wind the tether and hoist the load into the vehicle or onto the platform. The inventive device can be securely installed in a matter of seconds and removed just as quickly when no longer needed (such as when the vehicle operator needs to put on their seat belt to operate the vehicle).

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

### LIST OF REFERENCE NUMBERS

10 portable load assistant
12 winch
14 load attachment device
16 seat belt attachment device
18 housing
20 tether
22 button
24 toggle switch
26 spring closer
28 stop
30 tether protector
32 connector
34 tether
36 slip grasp device
38 joint
40 cotter pin

What is claimed is:

1. A portable load assistant comprising:
a winch, at least one load attachment device, and at least one seat belt attachment device,
wherein the winch is adapted to wind or unwind a tether portion of the at least one load attachment device, and the at least one seat belt attachment device is attachable to the winch, such that the winch is located between the load attachment device and the seat belt attachment device when installed or operated.

2. The portable load assistant of claim 1, wherein the winch comprises a motorized winch, a housing, and a power port.

3. The portable load assistant of claim 2, wherein the motorized winch comprises a self-contained power source.

4. The portable load assistant of claim 3 comprising at least two seat belt attachment devices, each attachable to the winch or housing at a common location.

5. The portable load assistant of claim 4, wherein each seat belt attachment device comprises a male buckle portion of a seat belt buckle and an adjustable length tether.

6. The portable load assistant of claim 5, wherein the winch is operable via operational controls located on the winch or housing.

7. The portable load assistant of claim 5, wherein the winch is operable via remote operational controls.

8. The portable load assistant of claim 6, wherein each of the male buckle portions of the seat attachment device is connected to a female buckle portion when installed.

9. The portable load assistant of claim 7, wherein each of the male buckle portions of the seat attachment device is connected to a female buckle portion when installed.

10. The portable load assistant of claim 8, wherein the female buckle portion is connected to a vehicle.

11. The portable load assistant of claim 9, wherein the female buckle portion is connected to a vehicle.

12. A method of transferring a load comprising:
attaching at least one seat belt attachment device to a vehicle;
attaching at least one load attachment device to a load to be transferred, wherein the at least one load attachment device is retractably attached to a winch via a tether portion of the at least one load attachment device; and
winding the tether portion of the at least one seat belt attachment device with the winch to transfer the load to the vehicle.

13. The method of claim 12, wherein the winch comprises a motorized winch, a housing, and a power port.

14. The method of claim 13, wherein the motorized winch comprises a self-contained power source.

15. The method of claim 14 comprising at least two seat belt attachment devices, each attachable to the winch or housing at a common location.

16. The method of claim 15, wherein each seat belt attachment device comprises a male buckle portion of a seat belt buckle and an adjustable length tether.

17. The method of claim 16, wherein the winch is operable via operational controls located on the winch or housing.

18. The method of claim 16, wherein the winch is operable via remote operational controls.

19. The method of claim 17, wherein each of the male buckle portions of the seat attachment device is connected to a female buckle portion installed on a vehicle.

20. The method of claim 18, wherein each of the male buckle portions of the seat attachment device is connected to a female buckle portion installed on a vehicle.
